(19) United States
(12) Patent Application Publication
(10) Pub. No.: US 2012/0173125 A1
(43) Pub. Date: Jul. 5, 2012

(54) METHOD FOR OPERATING AN INTERNAL COMBUSTION ENGINE

(75) Inventors: Carsten Baumgarten, Tettnang (DE); Johannes Eichmeier, Karlsruhe (DE); Christina Sauer, Friedrichshafen (DE); Arne Schneemann, Meckenbeuren (DE); Ulrich Spicher, Herxheim (DE); Christoph Teetz, Friedrichshafen (DE)

(73) Assignee: MTU Friedrichshafen GmbH, Friedrichshafen (DE)

(21) Appl. No.: 13/380,996

(22) PCT Filed: Jun. 24, 2010
(86) PCT No.: PCT/EP2010/003795

§ 371 Date: Mar. 13, 2012

(30) Foreign Application Priority Data
Jun. 26, 2009 (DE) 102009030837.7

(51) Int. Cl. F02D 41/30; F02M 69/04

(52) U.S. Cl. 701/105; 123/445

(57) ABSTRACT

The invention relates to a method for operating an internal combustion engine and a combustion chamber for such an internal combustion engine. According to the method, a thinned base mixture is ignited by additionally injecting a pilot fuel at an injection point in time, wherein the injection point in time of the pilot fuel is selected such that the pilot fuel is not fully homogenized with the base mixture.

### CROSS-REFERENCE TO RELATED APPLICATIONS

This application claims priority to German patent applications DE 10 2009 030 837.7 filed on Jun. 26, 2009 and PCT application PCT/EP2010/003795 filed on Jun. 24, 2010, which are hereby incorporated by reference in their entireties.

### TECHNICAL FIELD

The invention relates to a method for operating an internal combustion engine. Furthermore, the invention relates to a combustion chamber for an internal combustion engine to perform the method presented.

### BACKGROUND

In general, internal combustion engines can be divided into two types, namely spark-ignited and compression-ignited combustion engines.

In spark-ignited combustion engines usually a stoichiometric mixture of air and fuel is introduced into the cylinder of the internal combustion engine, subsequently a piston compresses said mixture, and a spark plug ignites it at a predetermined angle of the crank shaft.

Contrary thereto, compression-ignited internal combustion engines operate with a higher compression ratio, typically at a range from 15:1 to 22:1. Here, air is introduced into a cylinder and compressed. In the area of the end of the compression stroke, when the enclosed air has reached a sufficiently high temperature, the fuel is injected, which then ignites.

It must be observed, that future emission limits for so-called off-highway applications (e.g., EPA Tier4 effective as of 2014) cannot be achieved by improving present diesel combustion methods. Thus, in the future, complex exhaust treatment systems will be used, which, however, require high technical expenses and increased costs. In order to comply with future emission regulations at comparable costs new and improved combustion methods are required.

Due to the increased requirements shown with regard to fuel economy and emissions, increasingly efforts will be undertaken to develop highly efficient, compression-ignited internal combustion engines with efficient combustion methods and low emissions. Here, among other things, combustion methods of the compression ignition with a pre-mixed charge (PCCI: premixed charge compression ignition) and methods of compression ignition with homogenous charge (HCCI: homogenous charge compression ignition) are being discussed.

The publication DE 10 2006 007 279 A1 describes a method for operating a compression-ignited internal combustion engine which operates in the PCCI operating mode with a dual fuel injection system. Here, by way of injecting a secondary fuel into the inlet air flow or directly into the cylinder, the load limit of a smooth operation of a compression ignition engine is expanded.

Another PCCI combustion method is described in the publication U.S. Pat. No. 6,659,071 B2. Here, a first fuel is mixed with inlet air and a second fuel is directly injected.

In order to avoid the development of damaging particles and nitrous oxides as early as in the combustion chamber, in recent years increasingly HCCI combustion methods were examined. During the homogenous autoignition a homogenous, lean fuel-air mixture is inserted into the combustion chamber, which during the compression clock ignites almost simultaneously in the entire combustion chamber. In order to avoid any impermissibly high pressure gradients high dilution of the charge is required, leading to considerably reduced local combustion temperatures and thus also to almost no thermal formation of nitrogen oxide occurring. Due to the homogenous, lean mixture igniting almost simultaneously, no sooty particles are formed.

Numerous HCCI injection methods were presented, which are primarily distinguished in their way of forming the mixture. Here, examples are PREDIC, HCDC, HCCI, HPLI, etc. In these combustion methods continuous injection and combustion of the diesel fuel occurs largely decoupled, so that hardly any direct potential is given to access the start of combustion, which influences the emissions and the fuel consumption. Furthermore, it must be kept in mind that HCCI combustion methods show increased emissions of unburned hydrocarbons (HC) and carbon monoxide (CO) due to the lean, cold combustion. Another disadvantage is the limited range of the ignition map, in which the HCCI method can be realized. Limiting factors here are the maximally permissible pressure gradient and the permissible injection pressure, so that already in a partial load range it must be switched to respective conventional combustion methods, i.e. heterogeneously diesel and/or gasoline spark-ignited. These limiting parameters are largely dependent on the engine used and the application. With high loads pressure gradients occur in spite of diluted loads, which limit the range of operation of the HCCI combustion methods.

### SUMMARY

The presented method serves to operate an internal combustion engine, in which a homogenous basic mixture, typically strongly diluted with exhaust and/or air, is injected by an additional injection of a pilot fuel, with the time the pilot fuel is ignited being selected such that no complete homogenization occurs, i.e. only a partial homogenization, of the pilot fuel and the basic mixture.

In an embodiment, the pilot fuel is injected approximately 70 to 20° CA prior to IUDC, preferably 70 to 30° CA prior to IUDC.

Diesel may be used as the pilot fuel. In one embodiment the amount of the pilot fuel is equivalent to approximately 5% to 15% of the overall fuel amount, less under high loads, namely approximately 5%, than under low loads, namely approximately 15%.

Gasoline may be used as the fuel for the basic mixture. Other potential fuels for the homogenous basic mixture are isooctane, ethanol, methanol, LNG, LPG, or CNG. The basic mixture may include portions of a diesel fuel, in addition to these fuels. Alternatives for the pilot fuel are n-heptane, kerosene, or naphtha.

Furthermore, the time of injection may be selected depending on certain framework conditions. Here, the injection time may be adjusted depending on the number of injection sites.

In one embodiment of the method six to twelve injection sites are used to inject the pilot fuel.

The injection pressure of the pilot injection may range from 300 to 1,200 bar, preferably from 800 to 1,200 bar.

The basic mixture can be yielded with an air intake injection or via direct injection.

The presented combustion chamber in an internal combustion engine serves for a combustion method, particularly a combustion method of the type described above, and comprises a first device for inserting the fuel for a basic mixture and an injection for injecting a pilot fuel, with the combustion chamber being embodied such that this injection occurs depending on a crank angle of the internal combustion engine.

In one embodiment six to twelve injection sites are provided for injecting the pilot fuel.

An external exhaust recirculation and a dual charge may be provided.

Using the method described for operating an internal combustion engine, a so-called dual-fuel combustion method is presented (combustion method with two fuels), allowing the control of the autoignition of a homogenous air mixture, strongly diluted with exhaust and/or air, by the pilot injection of a small amount of ignitable fuel. The fuel in the basic mixture may be gasoline, for example. Diesel may be used as the pilot fuel. Here, the pilot fuel must reach the combustion chamber at a certain point of time, in order on the one hand to control the combustion and on the other hand to yield very low emissions of soot and nitrogen oxide.

The method requires, at least in some embodiments, an extremely high dilution of charge with exhaust-gas recirculation (EGR), because the ignitability of the mixture is increased by the targeted pilot injection.

Contrary to HCCI methods of prior art, the described combustion method can be used over the entire ignition map of an engine. In particular, future emission regulations can be fulfilled without any complicated and expensive exhaust treatment measures. Additionally, the option is provided to use different fuels.

In the dual-fuel combustion method presented, here a homogenous basic mixture, strongly diluted with air and/or exhaust, is securely and quickly ignited by the heterogenic injection of a small amount of an ignitable pilot fuel (e.g., diesel fuel, for example EN590, kerosene), approximately 5% to 15% of the overall amount of fuel. In this way it is achieved to use the advantages of the HCCI combustion method, while simultaneously avoiding the disadvantages connected thereto. The injection of an ignitable pilot fuel offers the chance to control the combustion. Simultaneously it ensures a secure ignition even at very high EGR rates. The moment of pilot injection is of decisive influence here upon the combustion and emissions.

Thus, it relates to an embodiment of a gasoline-HCCI combustion method, with its autoignition being controlled by the supply of an ignitable fuel.

Another dual-fuel combustion method is characterized by the connection of a gasoline-HCCI combustion method with the mechanic design and the application of a large-scale diesel engine. This combination allows covering of the entire range of the engine map of a C&I application. Therefore the switching is omitted between two combustion methods, which in turn facilitates the abilities for control and/or adjustment and allows the lowest possible emissions of nitrogen oxide and soot over the overall range of the engine map. In general, applications in the field of ship engines and generators are also possible.

When homogenous diesel combustion (diesel HCCI) is used, the high ignitability of the diesel fuel leads to such high pressure gradients, that even the mechanic load limits of large diesel engines can be exceeded. Thus, the Diesel HCCI combustion method shall primarily be used in partial load ranges (<50% load). Here, it must be observed that with the present structure (max. injection pressure <100 bar in aspirated engines) of gasoline engines and the requirements for acoustic and cold-start operation, the gasoline HCCI combustion method shall also be used only at lower loads and rotations.

Contrary thereto, diesel engines offer the optimal framework conditions for gasoline HCCI. These engines may be equipped with exhaust-gas recirculation (EGR) and a two-step charge so that the components for the required charge dilution are already provided. Due to the high permissible peak pressures of up to 230 bar a high dilution with EGR (60%) is possible, without reaching the limits of the mechanic stress. The high exhaust recuperation rate serves to adjust a desired start of the combustion and a desired combustion duration of the charge. The exhaust recuperation rate may depend on the load and rotation. Compared to an application in passenger vehicles, additionally higher pressure gradients are possible, for example 100 bar/ms), so that 20 bar of an effective average pressure at 1,300 l/min can be achieved without any restrictions. For this purpose, the dual-step exhaust-gas turbo charging (EGTC) shall be adjusted in order to provide the required air at maximum rotations. The turbines of the EGTC shall be selected smaller by a factor of 3 to 4 due to the required exhaust recuperation rate to dilute the charge in the combustion chamber relative to its flow rate compared to conventional diesel applications.

Due to the fact that the temperature of the cylinder charge is of decisive influence upon the combustion condition of the dual-fuel combustion a cooled EGTC shall be provided in order to yield maximum torque and maximum performance.

Additional advantages and embodiments of the invention are discernible from the description and the attached drawing.

It shall be understood that the examples mentioned above and explained in the following are applicable not only in the respectively shown combination, but can also be used in other combinations or standing alone without leaving the scope of the present invention.

### BRIEF DESCRIPTION OF THE DRAWINGS

The invention is explained using exemplary embodiments shown schematically in the drawing and in the following is described in greater detail with reference to the drawing.

FIG. 1 shows different mixture formations in the dual-fuel operation.

FIG. 2 shows pressure progressions depending on the time of the injection.

FIG. 3 shows the progression of injection and combustion.

### DETAILED DESCRIPTION

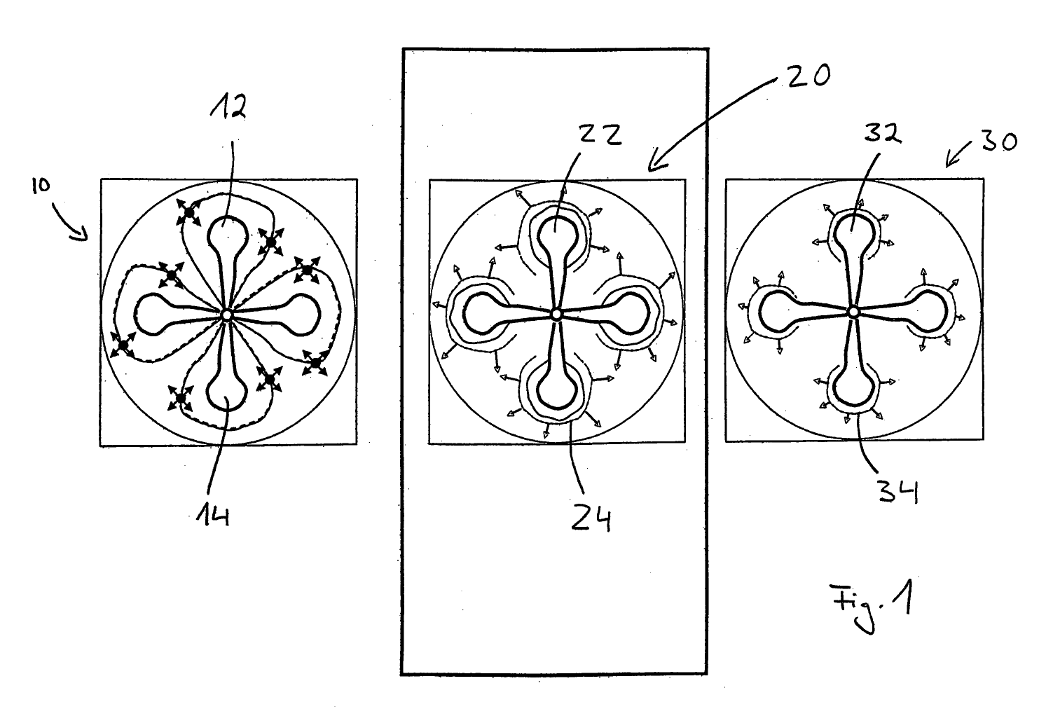

FIG. 1 shows different mixture formations with the corresponding combustion in the dual fuel-operation. Here, the injection of the pilot fuel occurs at different points of time in reference to the ignition TDC or ITDC (TDC: top dead center).

At the left side of the illustration a combustion chamber 10 is shown, in which a homogenous gasoline-diesel mixing range 12 is provided, with a pilot jet 14 being injected.

In the center of the illustration another combustion chamber 20 is shown with a homogenous gasoline-diesel mixture range 22 and a flame front 24.

At the right side of the illustration a third combustion chamber 30 is shown with a pilot jet 32 and a flame front 34.

FIG. 1 illustrates the influence of the times of injection of the amount of pilot fuel. When the pilot fuel is injected very early, approximately 180 to 70° CA prior to ITDC, into the combustion chamber 10, the ignitable pilot fuel mixes almost completely with the basic mixture at the time of ITDC, which is equivalent to a HCCI combustion method. In this case, the injection time is of no influence on the combustion charge. Very early injection times additionally lead to extremely low emissions of soot and NOₓ.

When the pilot fuel reaches the combustion chamber 20 approximately 70 to 20° CA prior to ITDC, less time is available for homogenization with the basic mixture. Due to the fact that the temperature at this point of time is still insufficient for igniting the pilot fuel a partial homogenization occurs and ignition starts in a more enriched range, which forms due to the pilot jet. Here the particles and nitrogen oxides remain at the same very low level as in the complete homogenous combustion in the combustion chamber 10. However, in this case the combustion status is controlled via the injection valve. Here, an early injection at the above-mentioned range of angles leads to a later combustion because the pressure and temperature levels here are lower than in a later injection, showing a shorter combustion delay.

When the pilot fuel, as shown on the right side of FIG. 1, is injected approximately 20 to 0° CA prior to ITDC, homogenization occurs only insufficiently and the combustion shifts towards earlier points of time, connected with strong knocking phenomena. NOₓ and soot emissions increase considerably here.

The illustration shows that an injection of the pilot fuel shall be targeted in a range from 70 to 20° CA prior to ITDC, with the pilot injection amount ranging from approximately 5% to 15% of the overall fuel amount. However, it must be observed that this range varies depending on other framework conditions, such as the number of injection sites in the fuel nozzle of the pilot fuel. With an increasing number of injection sites the homogenization of the fuel improves so that with twelve injection sites, compared to six injection sites, injection can occur approximately 10 to 20° CA later without leaving the partially homogenous range.

A number of injection sites from six to twelve has shown itself to be beneficial, preferably from eight to twelve, with their spatial arrangement also showing considerable effects upon the combustion. By the arrangement of the injection sites in two or more cascades in connection with different angles of the injection sites, the fuel can be better distributed in the combustion chamber. The ignition sources develop with a better spatial distribution, reducing the trend for knocking.

Furthermore, an injection pressure of the pilot injection from 300 to 1,200 bar has proven suitable. Higher pressures are not required due to the small amount of pilot fuel.

The required EGR rate varies depending on the load point. Although any dilution with air is sufficient up to the indicated average pressures of 11 bar and perhaps an EGR rate of 15% shows advantages with regard to consumption and emissions, in an indicated average pressure of 16 bar, 50 to 60% of external EGR is required in order to avoid knocking combustions and to ensure moderate rate increases of pressure.

It must be stated that a homogenous basic mixture can be yielded both with an air intake injection as well as with a direct injection.

The start of the combustion engine occurs in one embodiment with 100% pilot fuel. As soon as the engine has reached operating temperature (60 to 80° C. water temperature) the basic mixture is continuously increased until the amount of pilot fuel amounts to only approx. 5% to 15% of the overall fuel amount. In loads exceeding 3 bar pme and rotations of more than 1,000 rpm approximately 10%, in loads exceeding 12 bar pme, this amounts to approx. 5%. When idling, the pilot fuel amount may be increased (15%) in order to achieve secure ignition. Then the injection of the pilot fuel occurs from 70 to 20° CA. With increasing engine load the EGR rate increases from 0% when idling to approx. 50 to 70% at full load.

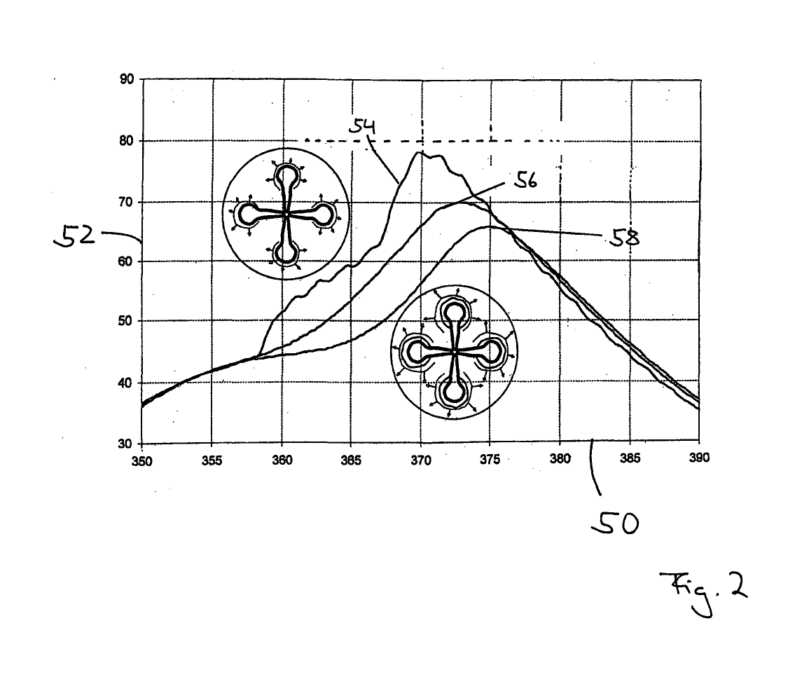

FIG. 2 shows different pressure gradients depending on the crank angle ° CA. Here, the crank angle ° CA is shown at the abscissa 50 and the pressure in the cylinder at the ordinate 52.

A first curve shows the progression at an injection time of the pilot fuel at 10° CA prior to IUDC. A second curve 56 shows the progression at 25° CA prior to ITDC. A third curve 58 shows the dependency at 35° CA prior to ITDC.

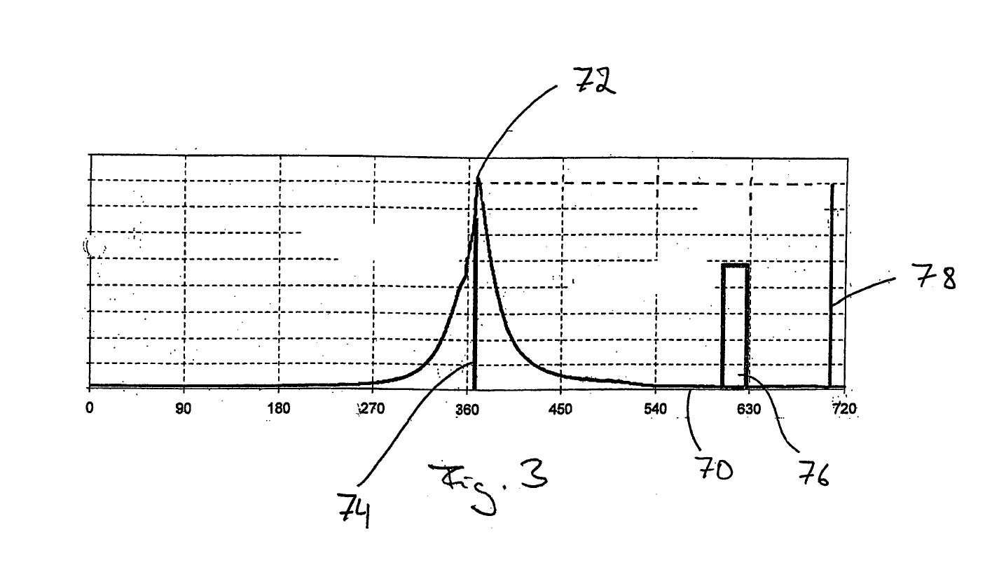

FIG. 3 shows the progression of the injection and the combustion. Here, the crank angle is shown in ° CA at the abscissa 70. A curve 72 shows the progression of the cylinder pressure. At a time 74 the pilot injection occurs. The injection of the gasoline occurs at a time 76. At a point of time 78 the inlet opens. FIG. 3 shows that the injection of the pilot fuel is performed during the compression.

1. A method for operating an internal combustion engine, in which a diluted basic mixture is ignited by additionally injecting a pilot fuel, with the injection time of the pilot fuel being selected such that no complete homogenization of the pilot fuel with the basic mixture occurs.

2. A method according to claim 1, in which the pilot fuel is injected approximately 70 to 20° CA prior to ITDC.

3. A method according to claim 1, in which diesel is used as the pilot fuel.

4. A method according to one of claim 1, in which the amount of pilot fuel approximately ranges from 5% to 15% of the entire fuel amount.

5. A method according to one of claim 1, in which gasoline is used as the fuel for the basic mixture.

6. A method according to one of claim 1, in which the ignition time is selected depending on certain framework conditions.

7. A method according to claim 6, in which the injection time is selected depending on the number of injection sites.

8. A method according to one of claim 1, in which six to twelve injection sites are used.

9. A method according to one of claim 1, in which the injection pressure of the pilot injection ranges from 300 to 1,200 bar.

10. A method according to one of claim 1, in which the basic mixture is yielded via an air intake injection.

11. A method according to one of claim 1, in which the basic mixture is yielded with a direct injection into the combustion chamber.

12. A method according to one of claim 1, in which the exhaust is recirculated for adjusting the duration of combustion of the charge.

13. A method according to claim 12, in which a sufficient filling of the combustion chamber with combustion air is provided by way of adjusting the air charge in the pressure level.

14. A combustion chamber in an internal combustion engine for a combustion method comprising a first device for introducing a fuel for a basic mixture and an injection for injecting a pilot fuel, with the combustion chamber being embodied such that this injection occurs depending on the crank angle of the internal combustion engine.

15. A combustion chamber according to claim 14, in which eight to twelve injection sites are provided to inject the pilot fuel.

16. A combustion chamber according to claim 14, in which an external exhaust recirculation and a dual charge are provided.
